(19) United States
(12) Patent Application Publication
(10) Pub. No.: US 2015/0334989 A1
(43) Pub. Date: Nov. 26, 2015

(54) Automatic Game Feeder Agitator

(71) Applicant: Isaac Morris, Forest Hill, LA (US)

(72) Inventor: Isaac Morris, Forest Hill, LA (US)

(21) Appl. No.: 14/717,317

(22) Filed: May 20, 2015

Related U.S. Application Data
(60) Provisional application No. 62/000,962, filed on May 20, 2014.

(51) Int. Cl. A01K 5/02

(52) U.S. Cl. CPC A01K 5/02; A01K 5/0225

(57) ABSTRACT

An automatic game feeder device is provided that ensures even and continuous flow of game from the hopper of the device while in operation. The game feeder includes a gravity feed hopper with a lower opening through which granular feed flows through and onto a spinner plate. The spinner plate accelerates the falling feed radially outward from the plate to spread the feed for animals to retrieve from the ground. The spinner plate is rotated by an electric motor and control unit. Extending from the spinner plate is an elongated agitator extending upwards into the opening of the hopper. The agitator is threaded, and optionally offset from the center of the spinner plate center of rotation. The agitator contacts the granular feed to prevent clogging or clumping thereof, and ensures a uniform flow when the agitator is rotated.

### CROSS REFERENCE TO RELATED APPLICATION

This application claims the benefit of U.S. Provisional Application No. 62/000,962 filed on May 20, 2014. The above identified patent application is herein incorporated by reference in its entirety to provide continuity of disclosure.

### BACKGROUND OF THE INVENTION

### Field of the Invention

The present invention relates to automatic game feeder devices that operate using a gravity feed to disperse feed from a hopper. More specifically, the present invention relates to an improvement to gravity fed automatic feeders, whereby a threaded hopper agitator is provided to agitate the granular feed in the hopper and ensure a uniform, continuous flow of feed therefrom when the device is operational.

The present invention provides a device that ensures corn flows properly through an automatic game feeder, thereby eliminating the need to check feeders for proper functioning on a regular basis or between refills of feed. The device comprises an automatic feeder having an agitator extending upwards from its spinner plate to prevent granular feed from floating or otherwise becoming clogged within the opening of the hopper. The agitator and spinner assembly is one that can be incorporated into automatic feeders of various types and brands, whereby the feed is gravity fed onto the spinner plate from a hopper.

Corn and other granular material are known to become clogged or otherwise erratically flow from automatic feeders. Given that automatic feeders are generally deployed over a period of unsupervised use, delays or impediments to the feed spreading process can impair the usefulness of the feeder. Game feeders of this type are generally employed to attract game to be hunted, whereby deer and other animals are attracted by the availability of the feed being disbursed from the feeder. The feeder is generally electrically driven and controlled by a control system that determines when and how often the feed is dispensed from the device.

The present invention offers an improved automatic feeder that ensures even flow of feed from the feed hopper over the period of unsupervised use, whereby clogging and clumping of feed (particularly when moist), is prevented in the hopper. The present invention provides a spinner plate that includes an upwardly directed agitator, whereby the agitator contacts the feed in the funnel and its threaded outer surface facilitates smooth dispensing of the feed onto the spinner plate. The agitator breaks up the granular feed material, while the threading creates friction between the agitator and the feed in the hopper as the agitator spins. Additional agitation of the feed is accomplished by offsetting a portion of the agitator from the center of rotation of the spinner plate, thereby creating a radial envelope in which the agitator occupies as it rotates with the spinner plate.

### SUMMARY OF THE INVENTION

The following summary is intended solely for the benefit of the reader and is not intended to be limiting in any way. The present invention provides a new automatic game feeder device that can be utilized for distributing granular feed from a hopper and ensuring uniform and continuous operation when unattended in the field.

It is an object of the present invention to provide an automatic game feeder device that comprises a hopper adapted to support a volume of granular feed therein, whereby the hopper has sidewalls, a lower opening, and an interior volume supporting the granular feed. A spinner plate is disposed below the lower opening of the hopper and a motor spins the spinner plate about a center of rotation. The granular feed is dispensed through the lower opening of the hopper using a gravity feed, whereby the granular feed drops onto the spinner plate and is jettisoned radially from the spinner plate such that animals can collect and consume the feed in an area around the device.

Another object of the present invention is to provide an automatic game feeder device having an elongated agitator that extends upward from the spinner plate and through the lower opening of the hopper to engage the granular feed. The agitator has an upper end and a lower end, whereby the agitator has an elongated length that extends through the lower opening of the hopper and into the interior volume thereof. The lower end of the agitator is secured to the spinner plate and spins in connection therewith as the motor drives the spinner plate.

Another object of the present invention is to provide an agitator that extends into the hopper of the automatic game feeder device, whereby the agitator has a threaded outer surface to induce the flow of the granular feed from the interior volume of the hopper, through the lower opening and onto the spinner plate.

Another object of the present invention is to provide an automatic game feeder device with an agitator, whereby the agitator further comprises a portion thereof along its length that is offset from the center of rotation of the motor to disturb the granular feed and induce flow from the interior volume of the hopper, through the lower opening and onto the spinner plate.

Another object of the present invention is to provide an automatic game feeder device with an agitator, whereby the lower end of the agitator is aligned with the center of rotation of the motor and the agitator is curved along its length such that the upper end of the agitator is offset from the center of rotation of the motor.

Another object of the present invention is to provide an automatic game feeder device with an agitator, whereby the agitator is offset from the center of rotation of the motor along its entire length.

Another object of the present invention is to provide an automatic game feeder device with an agitator, whereby the upper end of the agitator further comprises an enlarged member relative to the cross section of the agitator along its length.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of an embodiment of the automatic game feeder device of the present invention.

FIG. 2 shows a view of another embodiment of the automatic game feeder device of the present invention.

FIG. 3 shows a view of an exemplary embodiment of the automatic game feeder device of the present invention.

FIG. 4 shows a view of another embodiment of the automatic game feeder device of the present invention.

### DETAILED DESCRIPTION OF THE INVENTION

Reference is made herein to the attached drawings. Like reference numerals are used throughout the drawings to depict like or similar elements of the automatic game feeder device of the present invention. For the purposes of presenting a brief and clear description of the present invention, the preferred embodiment will be discussed as used for dispensing a continuous and even flow of granular feed from a hopper for distributing the same in an area around the feeder for attracting game animals thereto, and for ensuring continued operation over long periods of unsupervised use. The figures are intended for representative purposes only and should not be considered to be limiting in any respect.

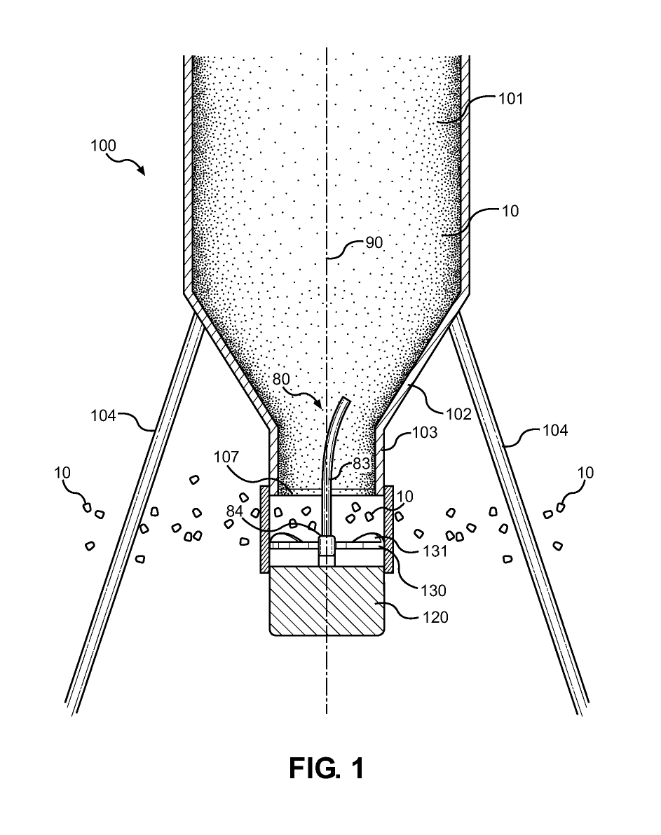

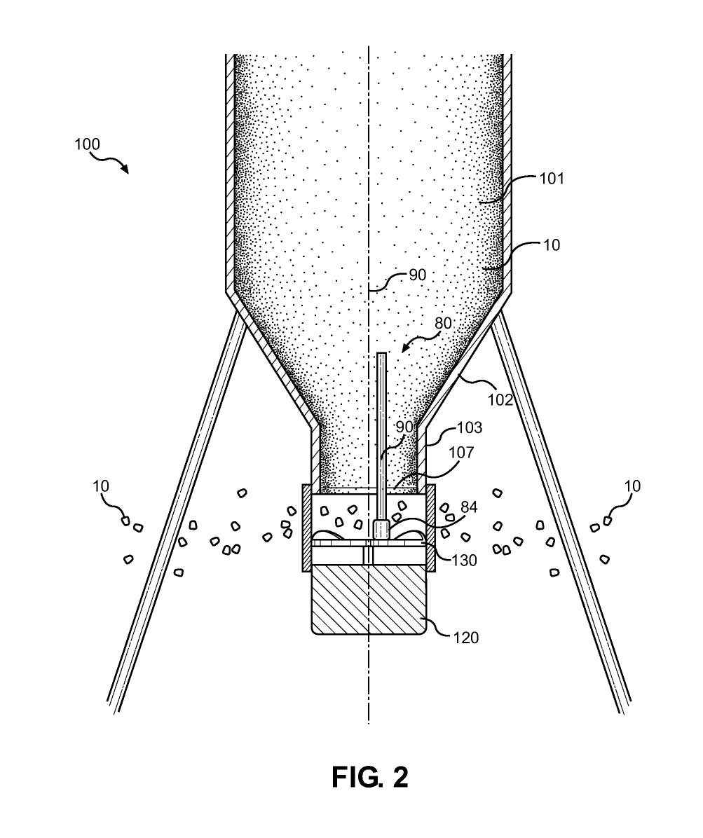

Referring now to FIGS. 1 and 2, there are shown cross sectional views of the automatic game feeder device of the present invention. The device comprises a hopper 100 that is adapted to hold granular feed 10 therein and funnel the feed through its lower opening 107 when the feed is dispersed. The hopper comprises upstanding sidewalls 102 that taper into a lower portion 103, whereby the feed 10 drops through a lower opening 107 and onto a spinner plate 130. The spinner plate 130 is disposed below the lower opening 107 and is used to distribute the feed 10 radially around the hopper in order to attract animals to the area. The spinner plate 130 may include upstanding fins 131 or other means for radially distributing the feed 10 as it drops from the hopper lower opening 107 thereonto as the spinner plate rotates 130.

Disposed below the spinner plate 130 is an electric motor housing, which supports an electric motor 120 and a motor controller. The electric motor 120 has a motor arm that drives the spinner plate 130 about its central axis and about the center of rotation 90 of the electric motor 120. The motor controller is programmed by the user to activate the motor 120 during certain intervals, thereby dispensing feed 10 from the hopper during predetermined periods and for given intervals. The motor controller is programmed to operate when the user is not present, thereby attracting game animals to the area for subsequent hunting. Alternative uses of the feed and the feeder device are contemplated aside from hunting activities. The hopper 100 is supported above the ground surface by a plurality of legs 104, which extend from the sidewalls 102 of the hopper and elevate the lower opening 107 and the spinner plate 130 above the ground. In this manner, the feed 10 is dispersed over a wide area as it is jettisoned radially outward from the spinner plate 130.

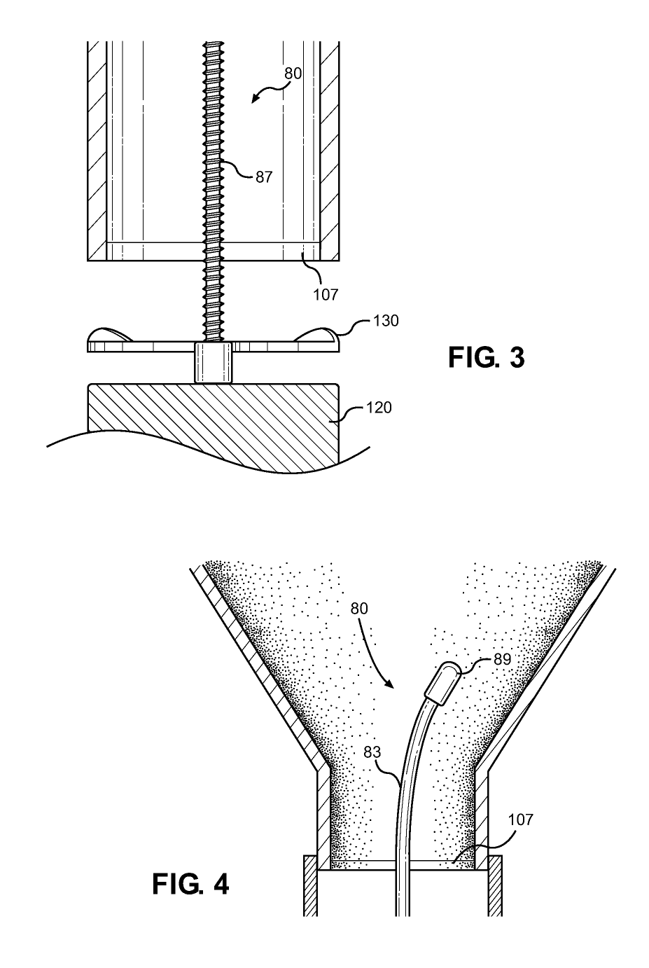

Referring to FIGS. 1-4, there are shown views of the lower opening 107 of the device. Extending upward from the spinner plate 130 is an agitator 80. The agitator 80 extends from the spinner plate 130 and enters the lower opening 107 of the hopper 100, whereby the agitator 80 is adapted to contact the granular feed 10 therein and ensure continuous flow thereof when the electric motor is energized. The agitator 80 comprises an elongated length with a lower end 84 and an upper end. The agitator 80 comprises a threaded outer surface 87 along its length, as shown in FIG. 3. The positioning of the agitator 80 through the lower opening 107 and the threaded surface 87 acts to disrupt the granular material and ensure the material flows through the lower opening 107 when the spinner plate 130 is active. This is particularly true if the granular material 10 becomes moist. The agitator 80 prevents clumping, and further disrupts the material in the lower end 103 of the hopper 100. This causes the material to separate and fall onto the spinner plate 130, thereby reducing instances of clogged or nonfunctioning periods of the feeder when the user is not present to remedy the issue.

Several embodiments of the agitator are contemplated. In one embodiment, the length of the agitator 80 is aligned with the center of rotation 90 of the spinner plate. The threading 87 and the spinning of the agitator 80 alone are sufficient to ensure continuous flow of feed when the motor is activated.

Alternate embodiments contemplate a portion 83 of the agitator 80 that is not aligned with the center of rotation 90 of the electric motor and spinner plate. The off-center portion may comprise a slight bend in the agitator along its length, or it may comprise an angle therealong.

Still other embodiments comprise an elongated, straight agitator as presented in FIG. 2, whereby the agitator 80 is positioned on the spinner plate 130 off-center from the center of rotation 90 of the spinner plate. The offset thereby causes the agitator 80 to traverse along a sweep around the center of rotation, displacing a volume within the lower opening 107 of the hopper for improved agitation and increased flow.

In yet another embodiment, a portion along the agitator length, and preferably along the upper end 89, comprises an increased cross section or weighted section. The larger section, as shown in FIG. 4, is also preferably offset from the center of rotation of the spinner plate, whereby the weight and increased size of the upper end 89 displaces more of the granular material as it traverses its sweep around the center of rotation. In all of the embodiments, the lower end of the agitator is preferably affixed to the spinner plate or affixed to the motor arm of the electric motor, whereby rotation is imparted onto the agitator by way of the spinner plate or via direct input from the motor.

Overall, it is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An automatic game feeder device, comprising:
a hopper adapted to support a volume of granular feed therein;
the hopper having sidewalls, a lower opening, and an interior volume;
a spinner plate below the lower opening of the hopper;
a motor spinning the spinner plate, whereby the motor has a center of rotation;
whereby the granular feed is dispensed through the lower opening using a gravity feed onto the spinner plate;
an elongated agitator extending from the spinner plate, the agitator having an upper end and a lower end;
the agitator having an elongated length that extends through the lower opening of the hopper and into the interior volume thereof;
the agitator having a threaded outer surface to induce flow of the granular feed from the interior volume of the hopper, through the lower opening and onto the spinner plate.

2) The automatic game feeder device of claim 1, wherein:
a portion of the agitator along its length is offset from the center of rotation of the motor to disturb the granular feed and induce flow from the interior volume of the hopper, through the lower opening and onto the spinner plate.

3) The automatic game feeder device of claim 2, wherein:
the lower end of the agitator is aligned with the center of rotation of the motor, and the agitator is curved along its length such that the upper end of the agitator is offset from the center of rotation of the motor.

4) The automatic game feeder device of claim 2, wherein the agitator is offset from the center of rotation of the motor along its entire length.

5) The automatic game feeder device of claim 2, wherein the upper end of the agitator further comprises an enlarged member relative to the cross section of the agitator along its length.
